(19) United States
(12) Patent Application Publication
(10) Pub. No.: US 2006/0101703 A1
(43) Pub. Date: May 18, 2006

(54) Reel seat for a fishing rod

(76) Inventor: Han-Chi Lu, Taichung City (TW)

Correspondence Address: CHARLES E. BAXLEY, ESQ., 90 JOHN STREET, THIRD FLOOR, NEW YORK, NY, 10038, US

(21) Appl. No.: 10/992,299

(22) Filed: Nov. 18, 2004

(51) Int. Cl. A01K 87/06

(52) U.S. Cl. 43/22

(57) ABSTRACT

A reel seat for a fishing rod is capable of providing a firm and comfortable grip, which is a mounting seat on a reel and comprises: a mounting portion formed on top of the mounting seat, a top surface of the mounting portion is arc-shaped, the mounting portion abuts closely against the outer surface of the fishing rod, and both ends of the mounting portion engage in a groove of the fishing rod and are located between the fishing rod and the hood; a cover portion beneath the mounting portion abuts closely against the hood and located above the groove of the fishing rod, and two notches are defined between the cover portion and the mounting portion.

### BACKGROUND OF THE INVENTION

1. Field of the Invention

The present invention relates to a reel, and more particularly to a reel seat for a fishing rod.

2. Description of the Prior Arts

Referring to FIG. 1, which shows a conventional reel 20 mounted on the fishing rod 10, in which, a groove 111 is formed on a grip portion 11 of the fishing rod 10. The fishing rod 10 is provided with a hood 12 which is moveable in axial direction of the hood 12, and a positioning groove 13 is defined between the fishing rod 10 and the hood 12. The reel 20 is provided with a mounting seat 21 having a first leg 211 and a second leg 212. The first leg 211 abuts closely against the peripheral surface of the fishing rod 10 and engages in the groove 111 of the grip portion 11, while the second leg 212 also abuts closely against the peripheral surface of the fishing rod 10 and is positioned by the hood 12. In this way, the reel 20 is fixed. However, this conventional reel 20 still has some defects that could be improved:

First, after the reel 20 is assembled on the fishing rod 10, the grip portion 11, the hood 12 and the two legs of the mounting seat 21 are not located in the same level so that an uneven and jagged surface will be formed. This conventional reel fails to provide a firm grip due to the overlarge clearances between the user's palm and fingers and the fishing rod 10, so that the fishing rod 10 cannot be easily controlled.

Second, still because the uneven and jagged surface caused by the grip portion 11, the hood 12 and the two legs of the mounting seat 21, the user will feel uncomfortable when holding the fishing rod 10, thus the control of the fishing rod 10 will be affected adversely.

The present invention has arisen to mitigate and/or obviate the afore-described disadvantages.

### SUMMARY OF THE INVENTION

The primary objective of the present invention is to provide a reel seat for a fishing rod capable of providing a firm and comfortable grip by reducing the clearance between the clearances between the fishing rod and the user's palm and fingers.

A reel seat for a fishing rod in accordance with the present invention includes a mounting seat formed on a reel, on the fishing rod is formed a groove and provided a hood, the mounting seat comprises:

a mounting portion is formed on top end of the mounting seat, a top surface of the mounting portion is concaved-arc-shaped, the mounting portion abuts closely against an outer surface of the fishing rod, and both ends of the mounting portion are inserted in the groove and located between the fishing rod and the hood;

a cover portion is located beneath the mounting portion, and two notches are defined between the cover portion and the mounting portion, and located opposite each other, the cover portion abuts closely against the hood and located above the groove of the fishing rod.

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 is a side view of a reel mounted on a fishing rod;

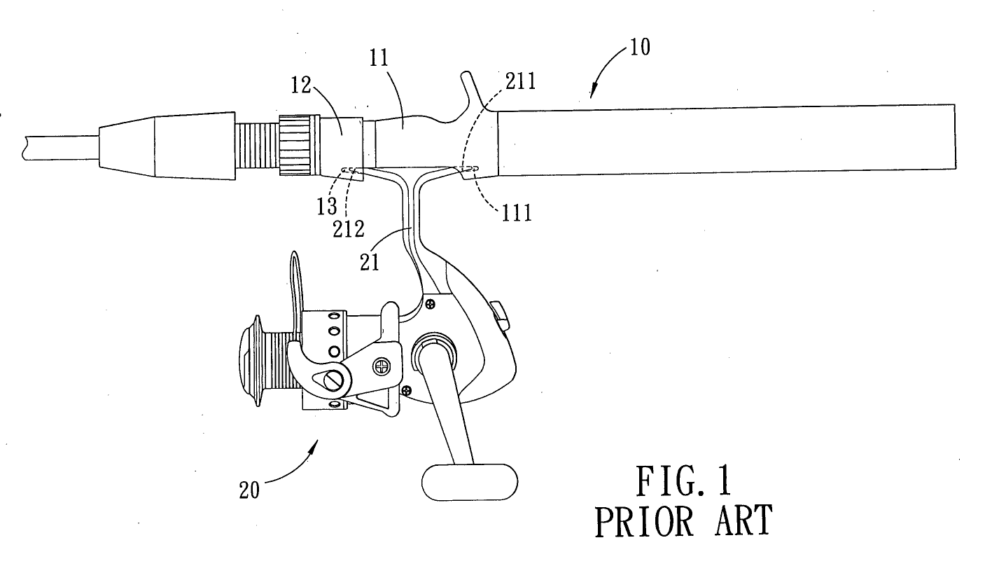

FIG. 2 is a side view of a reel seat in accordance with a first embodiment of the present invention;

FIG. 3 is an enlarged view of a part of FIG. 2;

FIG. 4 is a side view of a reel in accordance with a first embodiment of the present invention;

FIG. 5 is an amplified view of a part of the mounting seat of FIG. 4;

FIG. 6 is a top view of the mounting seat of FIG. 4;

FIG. 7 is a side view of a mounting seat of the reel in accordance with a second embodiment of the present invention;

FIG. 8 is an enlarged view of a part of FIG. 7.

### DETAILED DESCRIPTION OF THE PREFERRED EMBODIMENTS

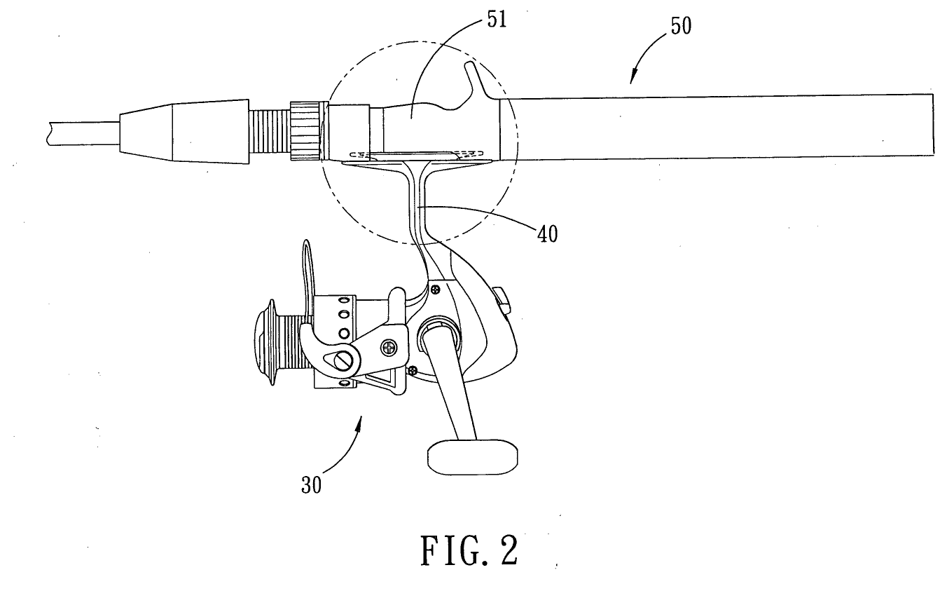

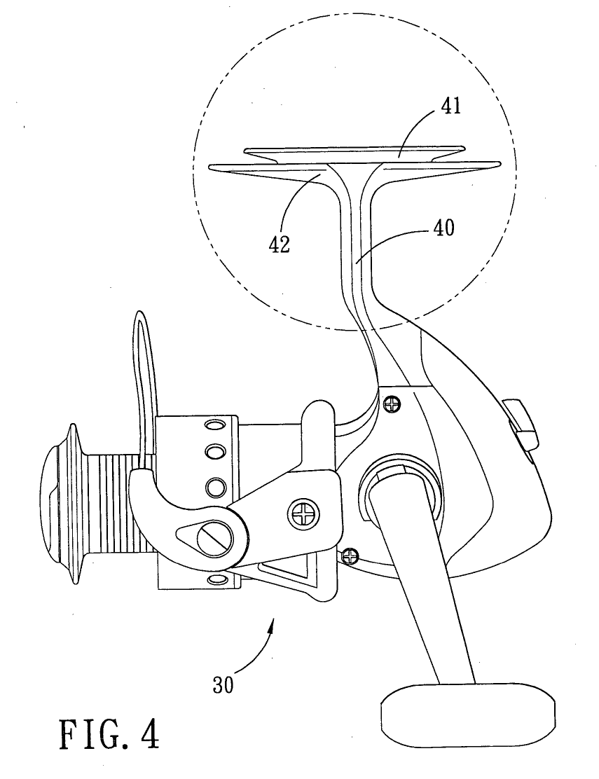

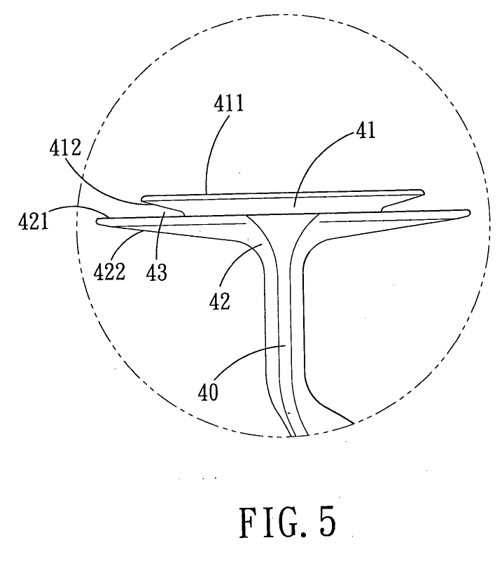

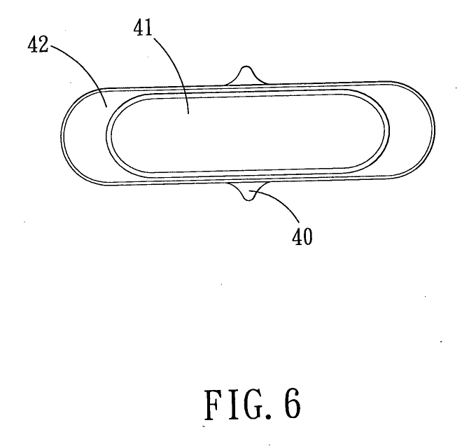

Referring to FIGS. 2-6, a reel seat for a fishing rod in accordance with a first embodiment of the present invention is shown, wherein a mounting seat 40 is formed on the reel 30, a groove 511 is formed in the grip portion 51 of the fishing rod 50, and a hood 52 is provided on the fishing rod 50. The mounting seat 40 comprises a mounting portion 41 and a cover portion 42.

The mounting portion 41 extending laterally from the top end of the mounting seat 40 is concave arc-shaped in longitudinal cross section, so that the top and the bottom surfaces 411, 412 of the mounting portion 41 are concaved-arc-shaped. The top surface 411 abuts closely against the outer surface of the fishing rod 50, and both ends of the mounting portion 41 are inserted in the groove 511 and located between the fishing rod 50 and the hood 52.

The cover portion 42 formed on the mounting seat 40 and located beneath the mounting portion 41, is longer than the mounting portion 41 and concave arc-shaped in longitudinal cross section, so that the top and the bottom surfaces 421, 422 of the cover portion 42 are concave-arc-shaped. Two notches 43 are defined between the top surface 421 of the cover portion 42 and the bottom surface 412 of the mounting portion 41, and located opposite each other. The top surface 421 of the cover portion 42 abuts closely against the hood 52 and located above the groove 511 of the fishing rod 50.

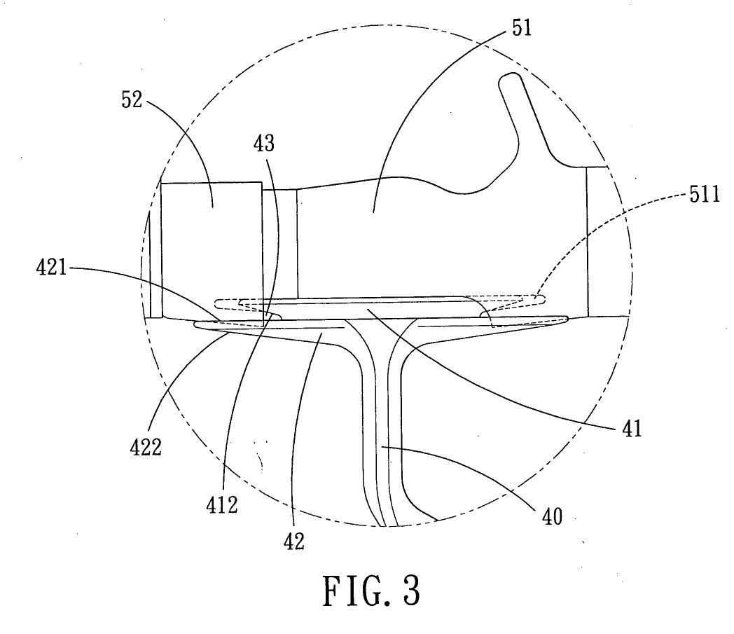

Referring particularly to FIGS. 2 and 3, since the mounting portion 41 of the mounting seat 40 is assembled on the grip portion 51 of the fishing rod 50 with its two ends inserted in the groove 511 and located between the fishing rod 50 and the hood 52, the reel 30 can be fixed firmly. Furthermore, the cover portion 42 beneath the mounting portion 41 abuts closely against the hood 52 and is located closely above the fishing rod 50 to cover the groove 511, so that the grip portion 51 of the fishing rod 50, the hood 52 and the mounting seat 40 are arranged to create a smooth surface. The bottom surface 422 of the grip portion 42 is arc-shaped, and the clearance between the fishing rod 50 and the user's palm and fingers will be relatively small as compared with the conventional reel seat, thus providing a firm grip on the fishing rod 50. And consequently, the fishing rod 50 can be controlled easily.

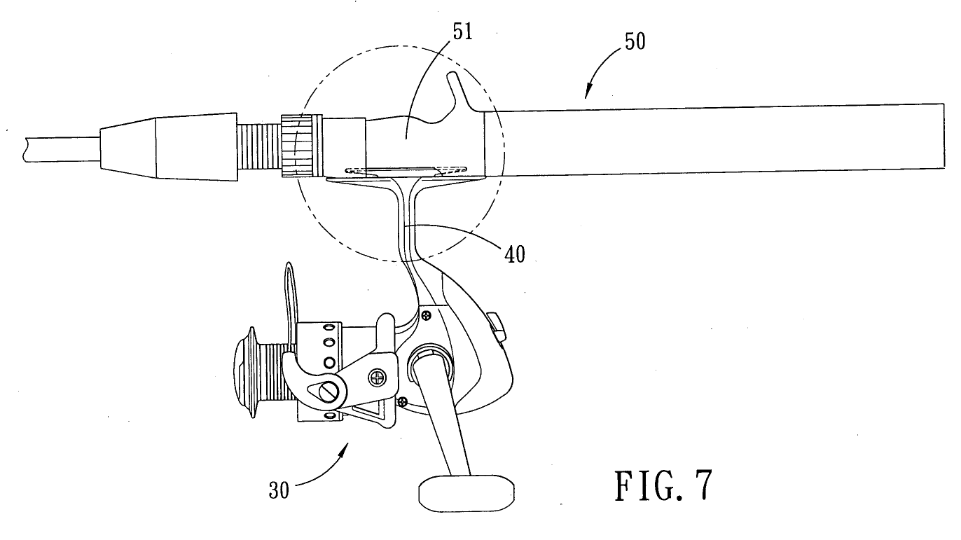

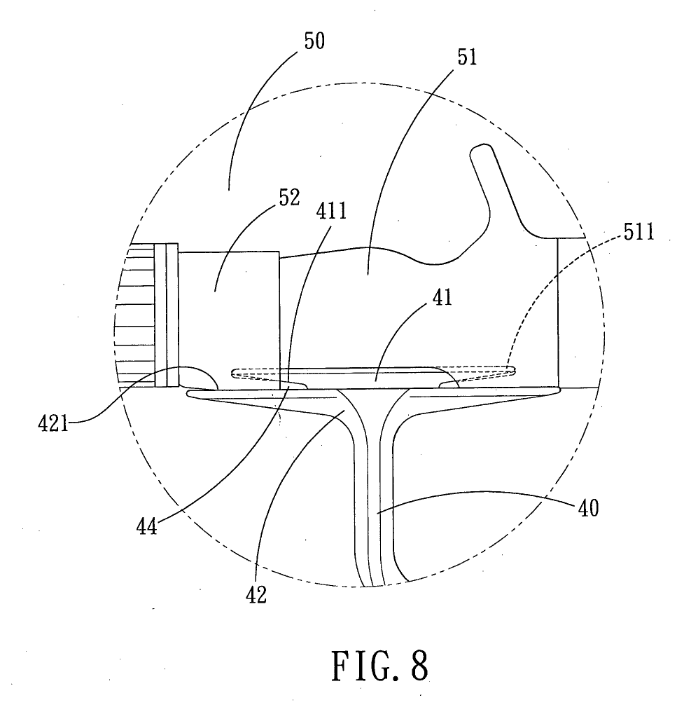

Referring to FIGS. 7 and 8, a reel seat for a fishing rod in accordance with a second embodiment of the present invention is shown, wherein the reel 30 is provided with a mounting seat 40, a groove 511 is formed in the grip portion 51 of the fishing rod 50, and on the fishing rod 50 is provided a hood 52. The mounting seat 40 comprises a mounting portion 41 and a cover portion 42. The second embodiment is functionally and structurally the same as the first embodiment, so further remarks will be omitted, and the differences are explains as follows:

Two opposite notches 44 between the top surface 421 of the grip portion 42 of the mounting seat 40 and the bottom surface 412 of the mounting portion 41 are deeper than the notches 43. The clearance between the top surface 421 of the grip portion 42 and the hood 52 and the groove 51 of the fishing rod 50 is relatively large, thus, besides the function and the effect of the first embodiment, the second embodiment can further produce a buffering effect, thus providing a more comfortable grip.

While we have shown and described various embodiments in accordance with the present invention, it should be clear to those skilled in the art that further embodiments may be made without departing from the scope of the present invention.

What is claimed is:

1. A reel seat for a fishing rod including a mounting seat formed on a reel, on the fishing rod formed a groove and provided a hood, wherein the mounting seat comprises:
a mounting portion formed on top end of the mounting seat, a top surface of the mounting portion is concaved-arc-shaped, the mounting portion abuts closely against an outer surface of the fishing rod, and both ends of the mounting portion are inserted in the groove and located between the fishing rod and the hood;
a cover portion is located beneath the mounting portion, and two notches are defined between the cover portion and the mounting portion, and located opposite each other, the cover portion abuts closely against the hood and located above the groove of the fishing rod.

2. The reel seat for a fishing rod as claimed in claim 1, wherein the grip portion is longer than the mounting portion.

3. The reel seat for a fishing rod as claimed in claim 1, wherein the mounting portion and the grip portion are concave arc-shaped in longitudinal cross section, so that the top and the bottom surfaces of the cover portion and the grip portion are concave-arc-shaped.

4. The reel seat for a fishing rod as claimed in claim 1, wherein the notches are defined between the bottom surface of the mounting portion and the top surface of the cover portion.

5. The reel seat for a fishing rod as claimed in claim 1, wherein the two notches are located opposite each other.
